(19) United States
(12) Patent Application Publication
(10) Pub. No.: US 2009/0089383 A1
(43) Pub. Date: Apr. 2, 2009

(54) SYSTEM AND METHOD FOR DETECTING CONTENT SIMILARITY WITHIN EMAILS DOCUMENTS EMPLOYING SELECTIVE TRUNCATION

(76) Inventor: Tsuen Wan Ngan, Los Angeles, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/059,130

(22) Filed: Mar. 31, 2008

Related U.S. Application Data
(60) Provisional application No. 60/976,455, filed on Sep. 30, 2007.

(51) Int. Cl. G06F 15/16

(52) U.S. Cl. 709/206

(57) ABSTRACT

A system and a method for detecting content similarities in different emails employing selective truncation are disclosed. In one embodiment, a method comprises generating a first token value dependent on a first subset of characters at a beginning portion of a first email document, generating a second token value dependent on a second subset of characters at an ending portion of a first email document, and depending upon the first and second token values, selectively generating one or more hash values corresponding to a sequence of characters between the first subset and the second subset. The method further comprises generating a third token value dependent on a third subset of characters at a beginning portion of a second email document, generating a forth token value dependent on a forth subset of characters at an ending portion of a second email document, depending upon the first and second token values, and selectively generating one or more hash values corresponding to a sequence of characters between the first subset and the second subset. The method finally comprises comparing the one or more hash values corresponding to the sequence of characters between the first subset and the second subset with the one or more hash values corresponding to the sequence of characters between the third subset and the fourth subset.

This application claims priority to U.S. provisional patent application Ser. No. 60/976,455, entitled “System And Method For Detecting Content Similarity Within Emails Documents Employing Selective Truncation”, filed Sep. 30, 2007.

### BACKGROUND OF THE INVENTION

1. Field of the Invention

This invention relates to email systems, and more particularly to the detection of similarities within email documents.

2. Description of the Related Art

Frequently, it is desired to efficiently find similar emails located in a database. Often, emails may be near duplicates because an email is forwarded or replied to without much added text. However, searching through an extensive database and comparing emails to determine potentially similar emails can be a problematic process. One approach for comparing emails for similarity is to compute a hash value from the content of differing emails and then compare the hash values for equality. Unfortunately, such approaches would typically only identify emails that are exact duplicates, since any differences in the emails would typically result in the generation of different hash values. Another possible approach is to compare every word of an email against the words of another to determine similarity. However, such an approach is typically very computationally intensive.

### SUMMARY

A system and a method for detecting content similarities in different emails employing selective truncation are disclosed. In one embodiment, a method comprises generating a first token value dependent on a first subset of characters at a beginning portion of a first email document, generating a second token value dependent on a second subset of characters at an ending portion of a first email document, and depending upon the first and second token values, selectively generating one or more hash values corresponding to a sequence of characters between the first subset and the second subset. The method further comprises generating a third token value dependent on a third subset of characters at a beginning portion of a second email document, generating a forth token value dependent on a forth subset of characters at an ending portion of a second email document, depending upon the first and second token values, and selectively generating one or more hash values corresponding to a sequence of characters between the first subset and the second subset. The method finally comprises comparing the one or more hash values corresponding to the sequence of characters between the first subset and the second subset with the one or more hash values corresponding to the sequence of characters between the third subset and the fourth subset.

### BRIEF DESCRIPTION OF THE DRAWINGS

FIG. 1 is a block diagram of a computer system suitable for implementing a similarity detection mechanism, according to one embodiment.

FIG. 2 is a flowchart of one embodiment of a method to compare email documents.

FIG. 3 depicts content of two exemplary emails.

FIG. 4 depicts two exemplary emails with extraneous content removed.

FIG. 5A depicts an example of tokenizing two words.

FIG. 5B depicts a list of tokenized words from the two exemplary emails.

FIG. 6 depicts exemplary sliding windows.

FIGS. 7 and 8 depict exemplary subsets from the two exemplary emails.

FIG. 9 depicts the exemplary hashed character sequences.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

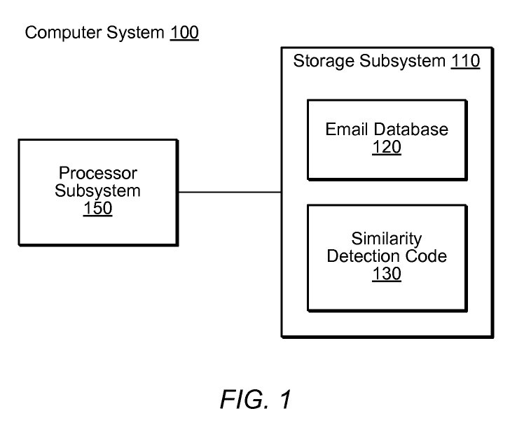

Turning now to FIG. 1, a block diagram of one embodiment of a computer system 100 is shown. Computer system 100 includes a storage subsystem 110 coupled to a processor subsystem 150. Storage subsystem 110 is shown storing an email database 120 and similarity detection code 130. Computer system 100 may be any of various types of devices, including, but not limited to, a personal computer system, desktop computer, laptop or notebook computer, mainframe computer system, handheld computer, workstation, network computer, a consumer device such as a mobile phone, pager, or personal data assistant (PDA). Computer system 100 may also be any type of networked peripheral device such as storage devices, switches, modems, routers, etc. Although a single computer system 100 is shown in FIG. 1, system 100 may also be implemented as two or more computer systems operating together.

Processor subsystem 150 is representative of one or more processors capable of executing similarity detection code 130. Various specific types of processors may be employed, such as, for example, an x86 processor, a Power PC processor, an IBM Cell processor, or an ARM processor.

Storage subsystem 110 is representative of various types of storage media, also referred to as “computer readable storage media.” Storage subsystem 110 may be implemented using any suitable media type and/or storage architecture. For example, storage subsystem 110 may be implemented using storage media such as hard disk storage, floppy disk storage, removable disk storage, flash memory, semiconductor memory such as random access memory or read only memory, etc. It is noted that storage subsystem 110 may be implemented at a single location or may be distributed (e.g., in a SAN configuration).

Email database 120 contains a plurality of email messages, each referred to herein as an email document, associated with one or more email system users. It is noted that various email documents within email database 120 may be duplicates of one another or may contain substantially similar content to that of other emails in the database (e.g., an initial email and a corresponding response email containing the initial email).

As will be described in further detail below, similarity detection code 130 includes instructions executable by processor subsystem 150 to identify email documents in database 120 that may be similar to one another (i.e., contain similar content). In various embodiments, email documents identified by similarity detection code 130 as being potentially similar may be reported to a user. In some embodiments, emails identified as being potentially similar may be further evaluated. For example, upon identification, potentially similar email documents may be analyzed or compared by additional code to determine and/or verify the extent of their similarity. Execution of similarity detection code 130 may allow efficient filtering of dissimilar email documents within email database 120.

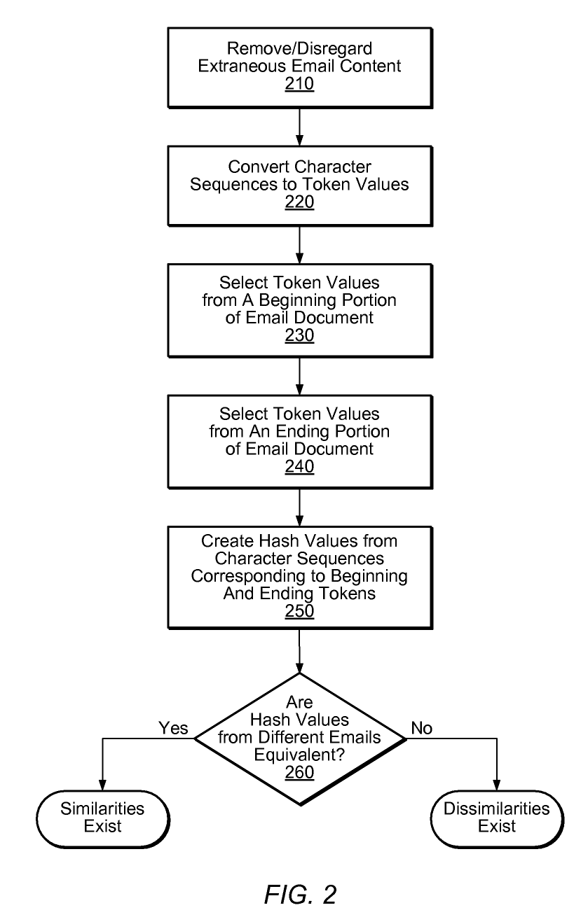

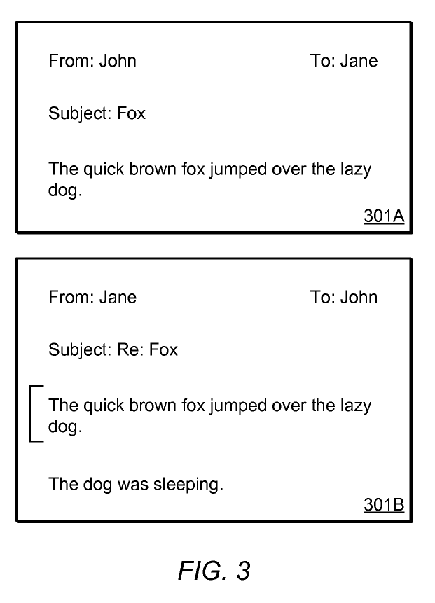

FIG. 2 is a flow diagram illustrating operations that may be carried out in accordance with execution of one embodiment of similarity detection code 130. Operations illustrated in FIG. 2 will be discussed in conjunction with an exemplary situation illustrated by FIG. 3, which shows two possible email documents 301A and 301B. As shown, email document 301B is a response to email document 301A. In this example, it is noted that the email documents 301A and 301B contain different email headers (e.g., the From, To, and Subject portions). It is also noted that an ending portion of email document 301B contains the sequence “The dog was sleeping.”, which is not included in email document 301A.

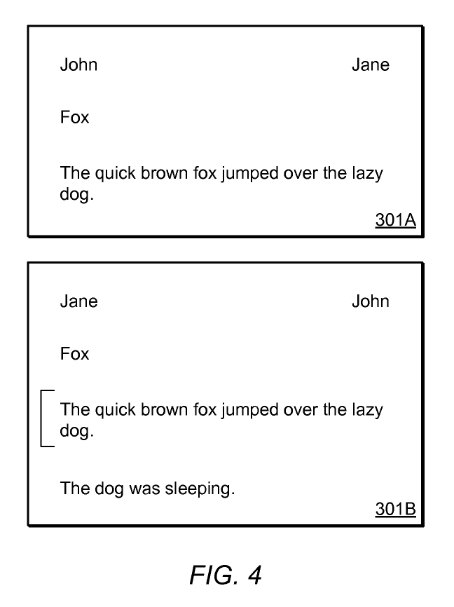

In step 210, extraneous email content in an email document being processed is removed or disregarded. This extraneous content may include common, reoccurring phrases found in typical email documents such as, “From [Name], To [Name], Subject [TITLE], On [DATE], at [TIME], [NAME] wrote:”, “Begin forwarded message:”, “- - - Original Message - - - ”, etc. An example of a result from this step is depicted in FIG. 4, where the headers have been removed from email documents 301A and 301B. In various embodiments, the extraneous email content removed/disregarded from each email document during step 210 may be predetermined or pre-selected words or phrases (e.g., phrases generally common to email documents). In other embodiments, the extraneous email content that is removed/disregarded may be controlled or specified by input from a user. It is noted that in some embodiments step 210 may be omitted.

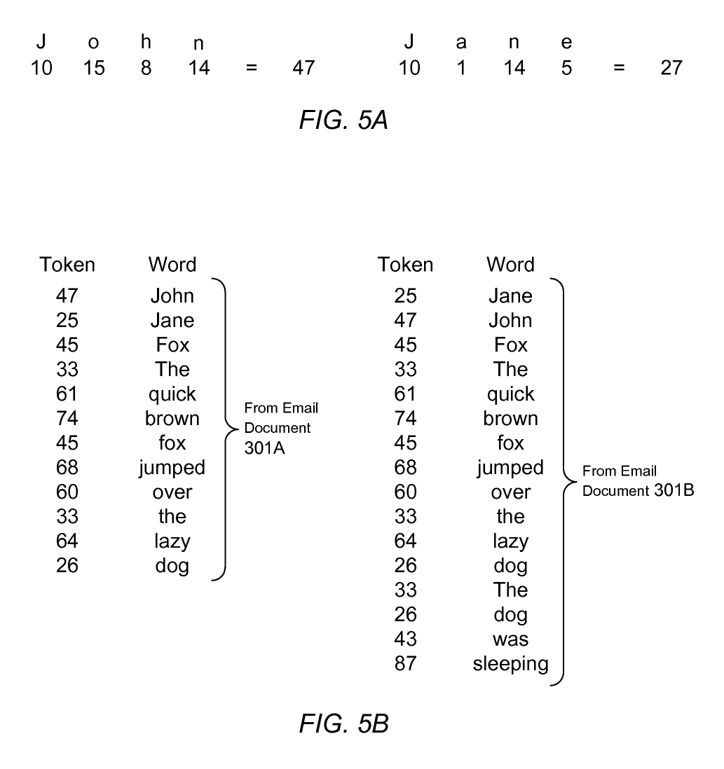

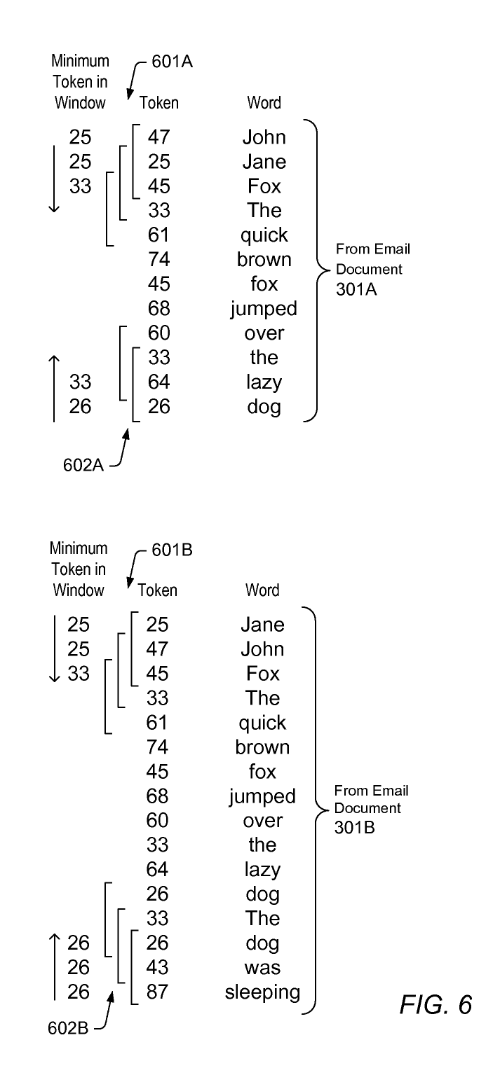

In step 220, the remaining content within the email documents being processed are converted to token values. A token value, as described in this disclosure, is a numerical value representative of or generated from a sequence of selected characters (e.g., a word, a sentence, a paragraph, or portion of a word). For example, FIG. 5A illustrates an example of generating token values according to one embodiment. In this example, the character sequences “John” and “Jane” are converted to the token values “47” and “25” by summing the alphabetic positions of characters in the words. For example, the character “J” is the 10^{th} letter in the alphabet and the character “o” is the 15^{th} letter. Thus, a token value of “47” is generated based on the sum of the alphabetic positions of the characters in the word “John”. Token values for other words (e.g., “Jane”) are created in a similar manner. FIG. 5B illustrates exemplary token values that may be generated for each of the words found in email documents 301A and 301B.

It is noted that token values may be generated in a variety of other ways during step 220. For example, in one alternative embodiment, ASCII character ordinal values, which associate numerical values with alphabetic characters or symbols, may be summed to create a token value for each word (in a similar manner as the embodiment described above). In other embodiments, other predetermined functions (e.g., hash functions), as desired, may be applied to values corresponding characters of a character sequence. It is noted that in some embodiments, the sequential ordering of characters in a character sequence may affect the value of a generated token value. For example, in such embodiments the word “top” may result in the generation of a token value that is different from that generated from the word “pot.”

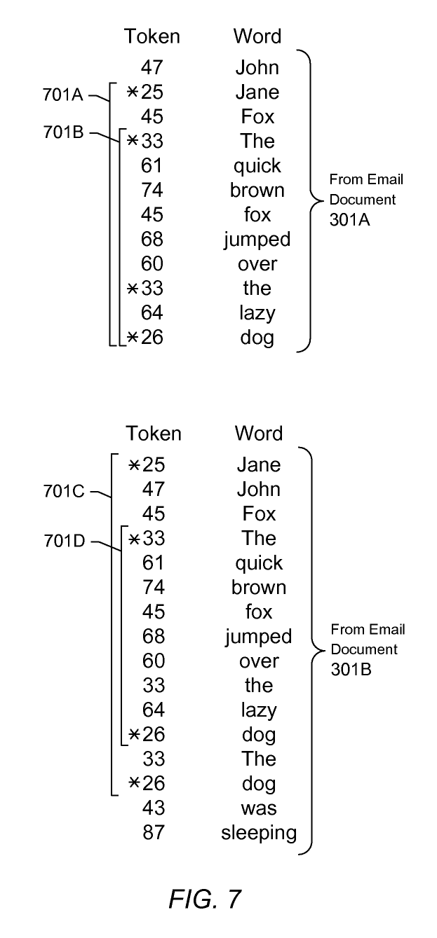

In step 230, generated token values are selected as truncation points from a beginning portion of the email document being processed. In one embodiment, token values are selected based on the minimum token value in a sliding window that moves across a beginning portion of the email document (e.g., the sliding window is incrementally moved upon successive iterations such that the token values of different subsets of words (or other sequences of characters) are selected upon each iteration for evaluation). FIG. 6 illustrates, such an example, where sliding windows 601A and 601B incrementally slide across beginning portions of email documents 301A and 301B. In this example, the token value 25 (Jane) is selected as a minimum value within sliding window 601A at the top positioning from the possible token values 47 (John), 25 (Jane), and 45 (Fox). As sliding window 601A moves downward, the token value 33 (the) is selected as another minimum value. Additional token values are selected in a similar manner as the sliding window proceeds through the beginning portion.

In step 240, generated token values are selected as truncation points from an ending portion of the email document being processed. In one embodiment, this operation is performed in the same manner as step 230; however, it is performed in an ending portion as opposed to a beginning portion. For example in one embodiment, shown in FIG. 6, sliding windows 602A and 602B are used to select tokens from an ending portion of email documents 301A and 301B, respectively.

It is also noted that size of the beginning and ending portions, upon which a sliding window is applied, may vary. In one embodiment, token values may be selected from only a small initial portion such as the email header. In some other embodiments, the size of the beginning and ending portions may be defined by some predetermined value or provided by a user input. Additionally, the size of a sliding window may vary from the embodiment depicted in FIG. 6.

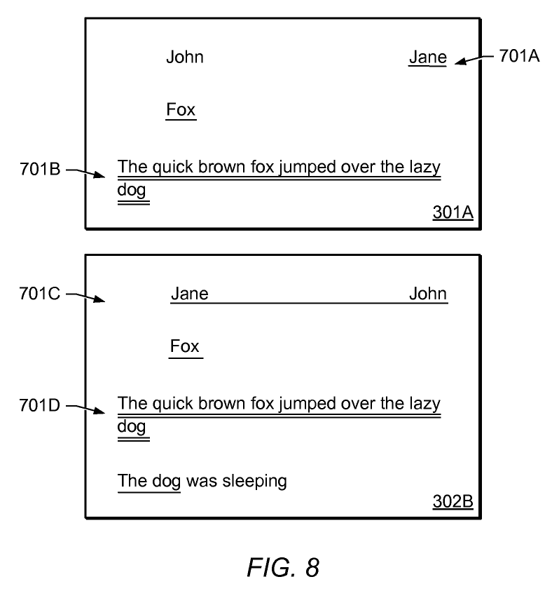

In step 250, one or more hash values are generated from character sequences that are contained in the email document between the selected beginning and ending token values (i.e., a token value selected from a beginning portion forms a truncation point at the beginning of the email document and a token value selected from an ending portion forms a truncation point at the ending of the email document such that a hash is generated from the contents contained between the beginning and ending truncation points). FIG. 7 illustrates exemplary character sequences from possible combinations of beginning and ending tokens (i.e., beginning and ending truncation points). For example, truncated character sequence 701A found in email 301A is created using beginning token 25 (Jane) and ending token 26 (dog). Similarly, truncated character sequence 701B is created using beginning token 33 (The) and ending token 26 (dog). This example is further illustrated in FIG. 8 where truncated character sequences 701 A, B, C, and D are underlined within email documents 301A and 301B. As depicted, truncated character sequences 701B and 701D contain the same words, while truncated character sequences 710A and 710C do not. It is noted that other truncated character sequences (not depicted in FIG. 7 and FIG. 8) can be created using the various beginning and ending tokens. It is also noted that in some embodiments, hash values may be generated including the words (or character sequences) that created the truncation points, while others may not.

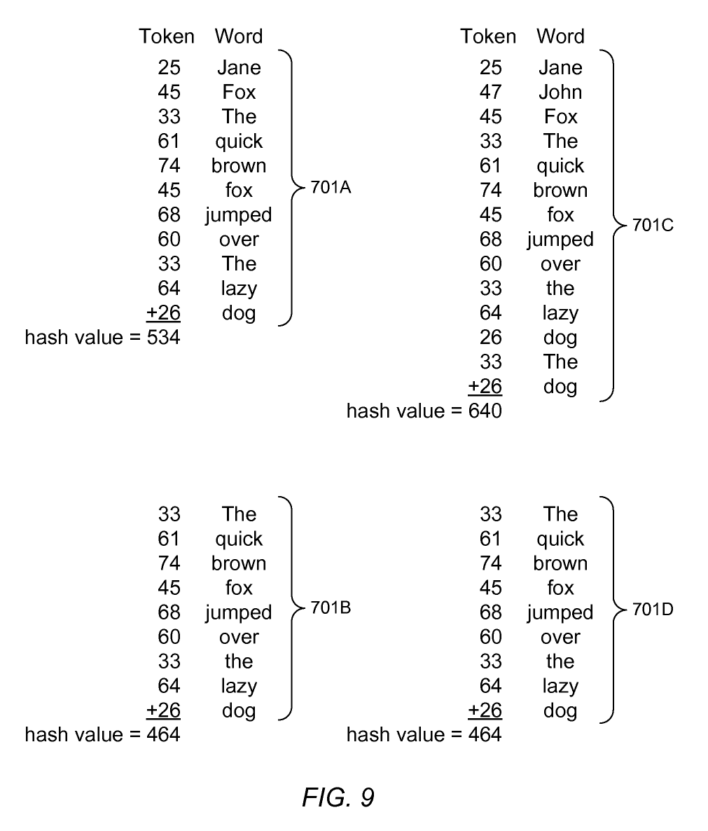

One embodiment for generating hash values in step 250 is depicted in FIG. 9. In this example, the token values (generated in step 220) of words that are contained between beginning and ending truncations points (generated in step 230 and 240) are summed to create hash values. Generally speaking, a “hash function” is any function that has a mapping of an input to a number (i.e., hash value). Thus, in various embodiments, specific hashing algorithms such as an MD5 hash, a SHA-1 hash, etc may be used. Accordingly, in some embodiments, the hash values generated in step 250 may be based upon a function that is independent of the token values generated in step 220.

In step 260, the hash values generated in step 250 are compared for equivalency. As shown in FIG. 9, truncated character sequences 701B and 701D have the same content, and thus an equivalent hash value (e.g., “464” in this example) is generated for each. On the other hand, truncated character sequences 701A and 710C do not contain the same content, and thus different hash values (e.g., “534” and “640”, respectively) are generated. Based on this hash value comparison, a similarity indication is generated.

It is noted that similarity detection code 130 may generate the similarity indication in a variety of ways. In some embodiments, the similarity indication may indicate that the email documents being analyzed are similar (or possibly similar) if any hash values resulting from the truncated character sequences in the different documents match. In yet other embodiments, the similarity indication may indicate that a similarity exists only if all hash values generated for the truncated character sequences in the different documents match. In various embodiments, similarity detection code 130 may be programmable by a user who can specify by input a minimum number of hash values that must match to cause an indication of similarity to be output. It is noted that the similarity indication may alternatively indicate that a dissimilarity exists between documents based on the result of the comparison performed in step 260.

Although in the embodiment described above token values and beginning/ending truncation points are generated on a word-by-word basis, other embodiments are also possible. For example, token values and truncation points may be created for other predetermined sequences of characters, such as each sentence, paragraph, or any other grouping of characters. It is noted that the term “character” as used herein is not limited to a letter; it may include numbers, symbols, punctuation, etc. Thus, in some embodiments, token values may be generated for character sequences that include punctuation or other symbols.

It is noted that in other embodiments beginning/ending truncations points may be generated in steps 230 and 240 using different techniques. For example, in one embodiment, rather than selecting a truncation point based on a minimum token value, other sliding window based functions may be applied. In yet other embodiments, other methodical functions may be applied to the token values to yield truncation points based on resultant values (e.g. generating truncation points based on odd numbered token values in beginning and ending portions of an email document).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
generating a first token value dependent on a first subset of characters at a beginning portion of a first email document;
generating a second token value dependent on a second subset of characters at an ending portion of the first email document;
depending upon the first and second token values, selectively generating one or more hash values corresponding to a sequence of characters between the first subset and the second subset;
generating a third token value dependent on a third subset of characters at a beginning portion of a second email document;
generating a fourth token value dependent on a fourth subset of characters at an ending portion of the second email document;
depending upon the third and fourth token values, selectively generating one or more hash values corresponding to a sequence of characters between the third subset and the fourth subset; and
comparing the one or more hash values corresponding to the sequence of characters between the first subset and the second subset with the one or more hash values corresponding to the sequence of characters between the third subset and the fourth subset.

2. The method of claim 1, further comprising:
iteratively generating a token value corresponding to each of a plurality of additional subsets of characters at the beginning portion of the first email document; and
selecting a plurality of truncation positions at the beginning portion of the first email document depending upon the token values.

3. The method of claim 1, further comprising:
iteratively generating a token value corresponding to each of a plurality of additional subsets of characters at the ending portion of the first email document; and
selecting a plurality of truncation positions at the ending portion of the first email document depending upon the token values.

4. The method of claim 2, further comprising generating a plurality of hash values wherein each hash value is generated based on a corresponding sequence of characters between a respective one of the plurality of truncation positions at the beginning portion of the first email document and a respective one at the end portion of the first email document.

5. The method of claim 1, further comprising generating a similarity indication in response to the comparing.

6. A computer-readable memory medium, storing program instructions that are computer-executable to:
generate a first token value dependent on a first subset of characters at a beginning portion of a first email document;
generate a second token value dependent on a second subset of characters at an ending portion of the first email document;
depending upon the first and second token values, selectively generate one or more hash values corresponding to a sequence of characters between the first subset and the second subset;
generate a third token value dependent on a third subset of characters at a beginning portion of a second email document;
generate a fourth token value dependent on a fourth subset of characters at an ending portion of the second email document;
depending upon the third and fourth token values, selectively generate one or more hash values corresponding to a sequence of characters between the third subset and the fourth subset; and
compare the one or more hash values corresponding to the sequence of characters between the first subset and the second subset with the one or more hash values corresponding to the sequence of characters between the third subset and the fourth subset.

7. The computer-readable memory medium of claim 6, wherein the program instructions are further executable to generate a similarity indication in response to comparing the one or more hash values corresponding to the sequence of characters between the first subset and the second subset with the one or more hash values corresponding to the sequence of characters between the third subset and the fourth subset.

8. The computer-readable memory medium of claim 6, wherein the program instructions are further executable to:
iteratively generate a token value corresponding to each of a plurality of additional subsets of characters at the beginning portion of the first email document; and
select a plurality of truncation positions at the beginning portion of the first email document depending upon the token values.

9. The computer-readable memory medium of claim 8, wherein the program instructions are further executable to generate a plurality of hash values, wherein each hash value is generated based on a corresponding sequence of characters between a respective one of the plurality of truncation positions at the beginning portion of the first email document and a respective one at the end portion of the first email document.

10. The computer-readable memory medium of claim 6, wherein one or more of the generated hash values are generated using an MD5 or SHA-1 hashing algorithm.

11. The computer-readable memory medium of claim 6, wherein the first and second subsets of characters includes words and wherein the first and second token values are generated based on one or more of the words.

12. The computer-readable memory medium of claim 6, wherein the token values are generated based on ASCII ordinal values of each character in a subset of characters.

13. The computer-readable memory medium of claim 6, wherein the token values are generated based on character positions of each character in a subset of characters.

14. A system, comprising:
one or more processors; and
memory storing program instructions that are executable by the one or more processors to:
generate a first token value dependent on a first subset of characters at a beginning portion of a first email document;
generate a second token value dependent on a second subset of characters at an ending portion of the first email document;
depending upon the first and second token values, selectively generate one or more hash values corresponding to a sequence of characters between the first subset and the second subset;
generate a third token value dependent on a third subset of characters at a beginning portion of a second email document;
generate a fourth token value dependent on a fourth subset of characters at an ending portion of the second email document;
depending upon the third and fourth token values, selectively generate one or more hash values corresponding to a sequence of characters between the third subset and the fourth subset; and
compare the one or more hash values corresponding to the sequence of characters between the first subset and the second subset with the one or more hash values corresponding to the sequence of characters between the third subset and the fourth subset.

15. The system of claim 14, wherein the program instructions are further executable to disregard predetermined content from the first and second email documents prior to generating the one or more hash values corresponding to the sequence of characters between the first subset and the second subset and the one or more hash values corresponding to the sequence of characters between the third subset and the fourth subset.

16. The system of claim 15, wherein the predetermined content includes email header information.

17. The system of claim 14, wherein the program instructions are further executable to generate a similarity indication in response to comparing the one or more hash values corresponding to the sequence of characters between the first subset and the second subset and the one or more hash values corresponding to the sequence of characters between the third subset and the fourth subset.

18. The system of claim 14, wherein the program instructions are further executable to generate a similarity indication in response to a user-specified minimum number of matching hash values between the first and second email documents.

19. The system of claim 14, wherein the program instructions are further executable to:
iteratively generate a token value corresponding to each of a plurality of additional subsets of characters at the beginning portion of the first email document; and
select a plurality of truncation positions at the beginning portion of the first email document depending upon the token values.

20. The system of claim 19, wherein the program instructions are further executable to generate a plurality of hash values, wherein each hash value is generated based on a corresponding sequence of characters between a respective one of the plurality of truncation positions at the beginning portion of the first email document and a respective one at the end portion of the first email document.
